(19) United States
(12) Patent Application Publication
(10) Pub. No.: US 2008/0119175 A1
(43) Pub. Date: May 22, 2008

(54) APPARATUS AND METHOD FOR SETTING TERMINAL STATE IN PORTABLE COMMUNICATION TERMINAL

(75) Inventors: Poong-Ki Min, Seoul (KR); Sung-Won Lee, Seongnam-si (KR); Sang-Do Lee, Seoul (KR); Sang-Jun Moon, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/764,650

(22) Filed: Jun. 18, 2007

(30) Foreign Application Priority Data
Jun. 19, 2006 (KR) 2006-0054708

(51) Int. Cl. H04Q 7/20

(52) U.S. Cl. 455/414.2; 455/456.3

(57) ABSTRACT

A terminal-state-setting apparatus and a method using a distance between a portable communication terminal and a user are provided. The terminal-state-setting method in the portable communication terminal includes measuring a distance between the terminal and a user-distance-recognizing device using a radio communication; and setting a state of the terminal according to the measured distance value. The user does not have to manually set the terminal state through the menu setup, and the user state can be accurately reflected through a presence service.

### PRIORITY

This application claims priority under 35 U.S.C. § 119(a) to an application filed in the Korean Intellectual Property Office on Jun. 19, 2006 and assigned Serial No. 2006-0054708, the contents of which are incorporated herein by reference.

### BACKGROUND OF THE INVENTION

1. Field of the Invention

The present invention relates generally to a portable communication terminal, and in particular, to an apparatus and method for setting a terminal state using a distance between the terminal and a user.

2. Description of the Related Art

Presence service accepts presence information indicative of communication availability from a service subscriber, stores the presence information to a presence server, and provides corresponding presence information according to a prescribed rule when a request is received from a user (hereafter, a watcher) who registers the subscriber as a buddy. The presence information includes contact means to the subscriber, current state, subscriber terminal information, and service and service element information. The watcher can actively demand the subscriber information, or be informed of the subscriber information being changed.

For instance, if the subscriber cannot communicate because of the meeting, the subscriber can change its current state information to ‘in meeting’. When the watcher wishes to contact the subscriber, it can acquire the unavailability information based on the current state information of the subscriber. The watcher may be led to use other communication means such as e-mail.

The current subscriber of the presence service uses a software menu embedded in the terminal to change the mode of the terminal, such as a ring/vibrate mode, a ring volume, and a presence status. For instance, the subscriber can press a shortcut key (e.g., ‘*’) to easily enter a vibrate mode.

As above, the conventional method causes the subscriber to manually change the terminal mode and the presence status and cannot perfectly support the subscriber state. For instance, when the subscriber stays away from the terminal in the vibrate mode, the terminal informs of an incoming call only using a vibration. Thus, the subscriber may not sense the incoming call. When the terminal of the subscriber is turned on, the presence service indicates on-line status all the time. In this situation, if the subscriber goes away from the terminal, the presence status is changed only when the subscriber changes his/her state in-person. Therefore, the real presence status of the subscriber is not published. In other words, the conventional method requires the user to manually set the terminal state and the terminal cannot accurately publish the terminal state.

### SUMMARY OF THE INVENTION

An aspect of the present invention is to substantially solve at least the above problems and/or disadvantages and to provide at least the advantages below. Accordingly, an aspect of the present invention is to provide a terminal-state-setting apparatus and method using a distance between a portable communication terminal and a user.

Another aspect of the present invention is to provide an apparatus and method for automatically changing the terminal setting of ring/vibrate, ring volume, and presence status based on a distance change measured between a portable communication terminal and a user.

The above aspects are achieved by providing a terminal-state-setting method in a portable communication terminal which includes measuring a distance between the terminal and a user-distance-recognizing device using a radio communication; and setting a state of the terminal according to the measured distance value.

According to one aspect of the present invention, a terminal-state-setting apparatus in a portable communication terminal includes a means for measuring a distance between the terminal and a user-distance-recognizing device using a radio communication; and a means for setting a state of the terminal according to the measured distance value.

According to another aspect of the present invention, a terminal-state-setting apparatus includes a terminal for measuring and storing a distance between the terminal and a user-distance-recognizing device using a radio communication, and setting a terminal state according to the measured distance value; and the user-distance-recognizing device for performing the radio communication with the terminal, the user-distance-recognizing device embedded to an object carried along by a user.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable communication terminal and a portable communication system according to the present invention;

FIG. 2 is a flowchart of a terminal-state-setting method using a distance between a portable communication terminal and a user according to the present invention;

FIG. 3 is a signal flow diagram for automatically changing a ring/vibrate mode and a ring volume according to a distance change between the portable communication terminal and the user according to the present invention; and

FIG. 4 is a signal flow diagram for automatically changing the presence status according to the distance change between the portable communication terminal and the user according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a terminal-state-setting apparatus and method by detecting a distance between a portable communication terminal and a user. Herein, the terminal state includes a ring/vibrate mode, a ring volume, and a presence status of the terminal.

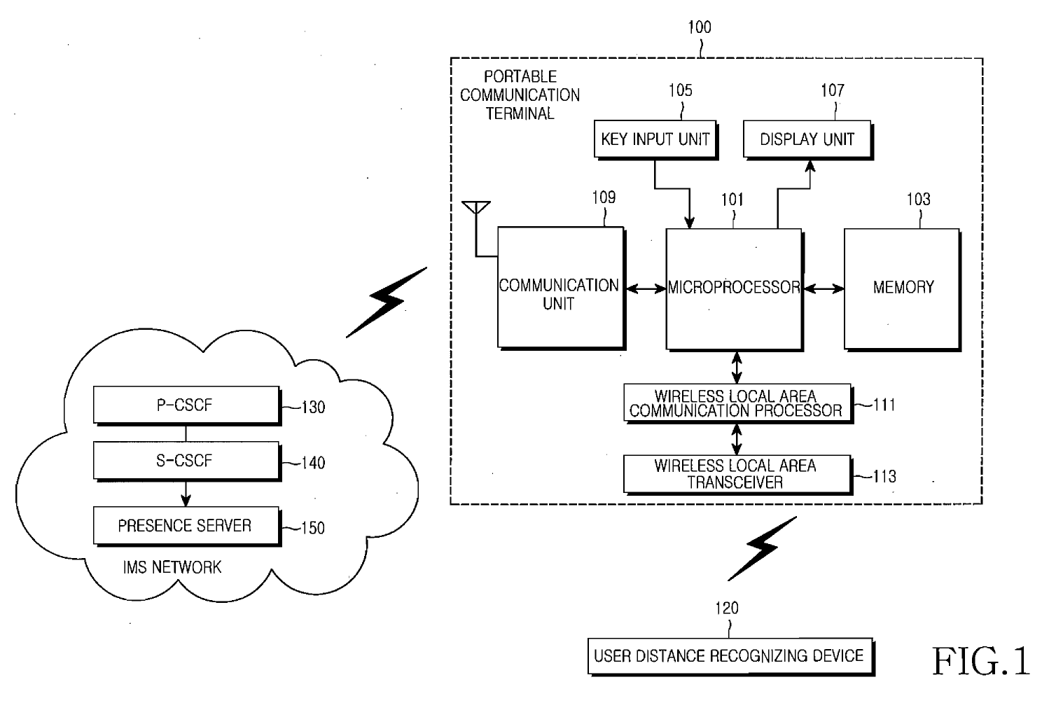

FIG. 1 is a block diagram of a portable communication terminal and a portable communication system according to the present invention. The portable communication terminal 100 includes a microprocessor 101, a memory 103, a key input unit 105, a display unit 107, a communication unit 109, a wireless local area communication processor 111, and a wireless local area transceiver 113. The portable communication system includes the portable communication terminal 100, a user-distance-recognizing device 120, Proxy-Call Signal Call Function (P-CSCF) 130, Serving-Call Signal Call Function (S-CSCF) 140, and a presence server 150.

In the portable communication terminal 100 of FIG. 1, the microprocessor 101 controls overall operation of the portable communication terminal 100. For instance, the microprocessor 101 performs general functions to process and control voice communications and data communications, and also functions to measure and store a distance between the terminal and a user through a radio communication with the user-distance-recognizing device 120 and to set the terminal state, for example, the ring/vibrate mode, the ring volume, and the presence status according to the measured distance. Herein, when the distance to the user satisfies a condition for changing the ring/vibrate mode or the ring volume, the microprocessor 101 enters a corresponding ring/vibrate mode or adjusts to a corresponding ring volume. When the distance to the user satisfies a condition for changing the presence status, the microprocessor 101 generates a PUBLISH message and sends the generated PUBLISH message to the presence server 150 via the P-CSCF 130 and the S-CSCF 140. The PUBLISH message is a message transmitted to a server managing specific information to update the specific information.

The memory 103 can be implemented using a Read Only Memory (ROM), a Random Access Memory (RAM), a flash ROM, and the like. The ROM stores microcodes of programs and various reference data for the processing and the controlling at the microprocessor 101. Particularly, according to the present invention, the ROM stores programs for measuring and storing the distance between the terminal and the user through the radio communications with the user-distance-recognizing device 120, and for setting the terminal state, for example, the ring/vibrate mode, the ring volume, and the presence status based on the measured distance. The RAM, which is a working memory of the microprocessor 101, stores temporary data generated during program executions. The Flash ROM stores updatable data to keep, for example, document data.

The key input unit 105 has a plurality of function keys such as number keys 0˜9, a menu button, a DELETE button, an OK button, a TALK button, an END button, an Internet access button, navigation buttons (or direction keys), and buttons ▴/▾/ [symbol] . The key input unit 105 provides the microprocessor 101 with key input data corresponding to a key pressed by the user. The display unit 107 displays status information generating in the operation of the portable terminal, a limited number of characters, videos, and still images. The display unit 107 can employ a Liquid Crystal Display (LCD).

The communication unit 109 processes transmission and reception of radio signals input and output over an antenna. For instance, in the transmission, the communication unit 109 channel-codes, spreads, Radio Frequency (RF)-processes, and transmits data. In the reception, the communication unit 109 despreads, channel-decodes, and restores the received RF signal.

The wireless local area communication processor 111 is a device for interfacing between the wireless local area transceiver 113 and the microprocessor 101. The wireless local area communication processor 111 encodes a signal fed from the microprocessor 101 and provides the encoded signal to the wireless local area transceiver 113, decodes a signal received from the wireless local area transceiver 113 and outputs the decoded signal to the microprocessor 101.

The wireless local area transceiver 113 receives the converted signal from the wireless local area communication processor 111, provides the received signal to the user-distance-recognizing device 120 through the wireless local area communications such as Bluetooth® (herinafter “Bluetooth”), InfraRed Data Association (IrDA) communication, Radio Frequency IDentification (RFID), and Ultra-WideBand (UWB), and provides the signal received from the user-distance-recognizing device 120 through the wireless local area communications to the wireless local area communication processor 111. In case that IrDA communication is adopted as the wireless local area communications, the transmitter can use an infrared Light Emitting Diode (LED) and the receiver can use an IrDA photo diode.

The user-distance-recognizing device 120 transmits and receives signals to and from the terminal in the wireless local area communications with the terminal. The user-distance-recognizing device 120 can be embedded within various products constantly used and carried along by the user, for example, within glasses, shoes, watches, and so forth.

The P-CSCF 130 serves as an initial contact point for the terminal 100 within an Internet Protocol (IP) Multimedia Subsystem (IMS) network. In an Session Initiation Protocol (SIP) registration, the P-CSCF 130 acts as a proxy between the terminal 100 and an Interrogating-Call Signal Call Function (I-CSCF) (not shown). In the SIP call setup, the P-CSCF 130 acts as a proxy between the terminal 100 and the S-CSCF 140. The SIP is an application protocol for the signaling of a Voice Over Internet Protocol (VoIP) and other application services. Also, the P-CSCF 130 manages a security association between the terminals, and compresses and decompresses the SIP message. In addition to the general functions, the P-CSCF 130 provides a PUBLISH message received from the terminal 100 to the S-CSCF 140, and provides a response message received from the S-CSCF 140 to the terminal 100.

The S-CSCF 140 executes the SIP registration, controls sessions for the registered user, and manages a session status. Also, the S-CSCF 140 interworks with a service platform to provide various services, and interworks with a Breakout Gateway Control Function (BGCF) to route a message destined for a Public Switched Telephone Network (PSTN). Besides the general functions, the P-CSCF 130 provides the PUBLISH message received from the P-CSCF 130 to the presence server 150, and provides a response message received from the presence server 150 to the P-CSCF 130.

The presence server 150 performs functions for a user presence publication acceptance, a user presence subscription acceptance, a presence merging from various presence sources, a user presence notification, a presence authorization rule amendment, and a subscription authorization based on a subscription control policy. In addition to the general functions, the presence server 150 performs the publisher authorization with respect to the terminal 100 which transmits the PUBLISH message, changes the presence state of the corresponding user, generates a response message, that is, 200 OK message, and transmits the generated message to the S-CSCF 140.

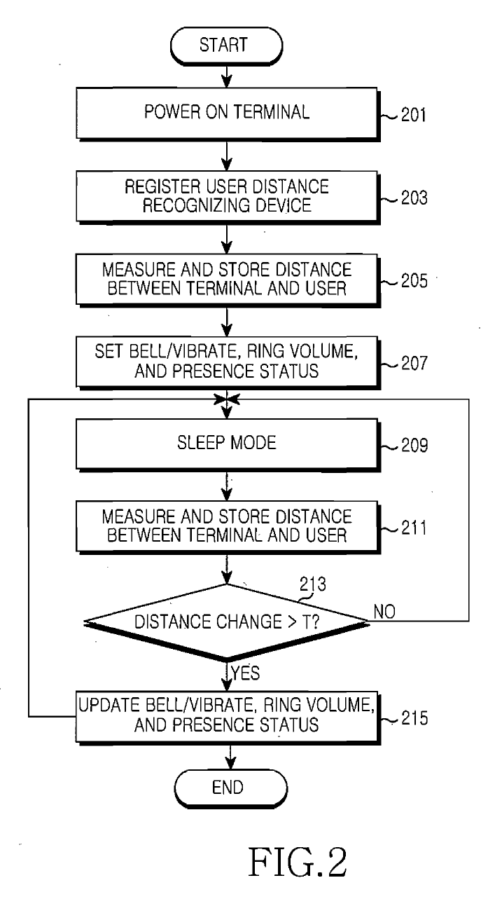

FIG. 2 is a flowchart of a terminal-state-setting method using a distance between the portable communication terminal and the user according to the present invention.

In FIG. 2, the terminal 100 is turned on by a key manipulation of the user in step 201. In step 203, the terminal 100 searches for the user distance-recognizing device 120 in a vicinity using the radio communication technology and registers the discovered user-distance-recognizing device 120 to the memory 103 as a device for measuring the distance between the user and the terminal 100. The user-distance-recognizing device 120 can be embedded within any kind of product constantly used and carried along by the user, such as, glasses, shoes, and watches, to transmit and receive signals to and from the terminal 100 in the wireless local area communication.

The terminal 100 measures the distance to the registered user-distance-recognizing device 120 using the wireless local area communication and stores the measured distance to the memory 103 in step 205. Next, the terminal 100 sets the terminal state, for example, the initial ring/vibrate mode, the ring volume, and the presence status, based on the measured distance in step 207. For instance, when the measured distance is short, the initial mode can be set to the vibration mode. When the measured distance is long, the initial mode can be set to the ring mode or the silence mode.

In step 209, the terminal 100 enters the idle state, that is, a sleep mode. After a certain time, the terminal 100 awakes from the sleep mode, re-measures the distance to the user-distance-recognizing device 120, and stores the measured distance to the memory 103 in step 211. In step 213, the terminal 100 calculates a change of the measured distance and checks whether the change of the measured distance is greater than a threshold T. The threshold T is a reference value for resetting the terminal state.

When the change of the measured distance is greater than the threshold T, the terminal 100 determines that the user is far away enough to reset the terminal state, that is, determines the condition for changing the terminal state is satisfied, resets the terminal state, for example, the ring/vibrate mode, the ring volume, and the presence status according to the distance change value, and then returns to step 209. For instance, when the distance change meets the user presence status change condition, the terminal 100 generates and transmits the PUBLISH message including the presence status change information to the P-CSCF 130 over a wired/wireless network. If the user is placed quite far away from the terminal, the PUBLISH message may include user off-line state information. If the user is located not far from the terminal, the PUBLISH message may include user on-line state information. Next, the terminal 100 finishes this algorithm.

By contrast, when the change of the measured distance is not greater than the threshold T, the terminal 100 determines that the distance to the user is too close to reset the terminal state and returns to step 209.

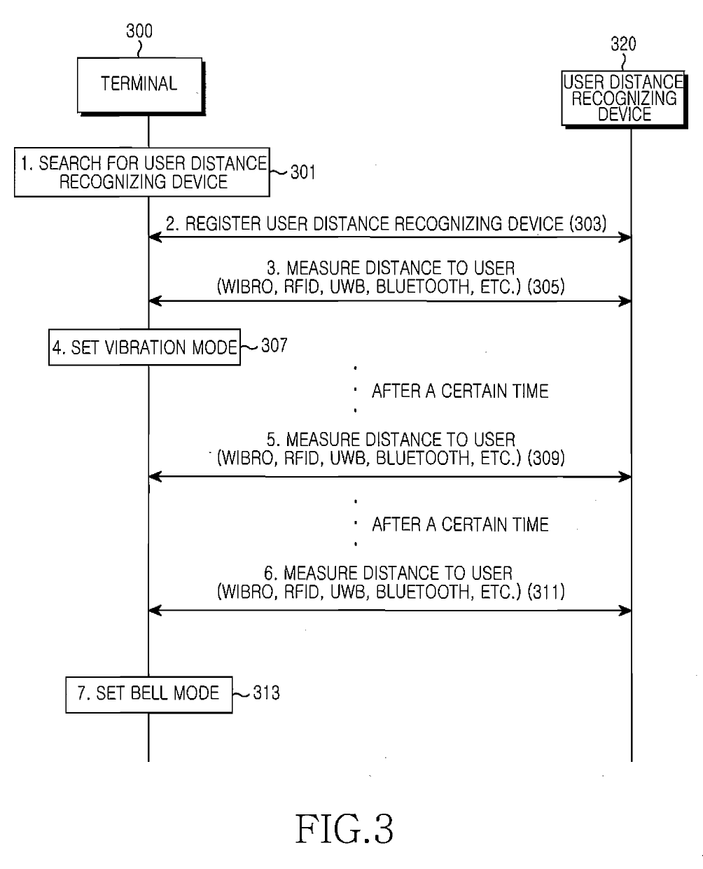

FIG. 3 is a signal flow diagram for automatically changing the ring/vibrate mode and the ring volume according to the distance change between the portable communication terminal and the user according to the present invention.

Terminal 300 of FIG. 3 searches for a user-distance-recognizing device 320 in step 301 and registers the searched user-distance-recognizing device 320 to the memory as a device for measuring the distance between the user and the terminal 300 in step 303. Next, the terminal 300 measures the distance between the user and the terminal 300 by transmitting and receiving radio signals to and from the user-distance-recognizing device 320 in step 305. When the measured distance between the user and the terminal 300 satisfies the condition for entering the vibration mode, the terminal 300 sets the terminal mode to the vibration mode in step 307 and enters the sleep mode for a certain time. After the certain time passes, the terminal 300 awakes from the sleep mode and re-measures the distance to the user in step 309. When the measured user distance does not meet the terminal state change condition, the terminal 300 re-enters the sleep mode for a certain time. After the certain time, the terminal awakes from the sleep mode and re-measures the user distance in step 311. At this time, when the measured user distance meets the condition for entering the ring mode, the terminal 300 sets the terminal mode to the ring mode in step 313.

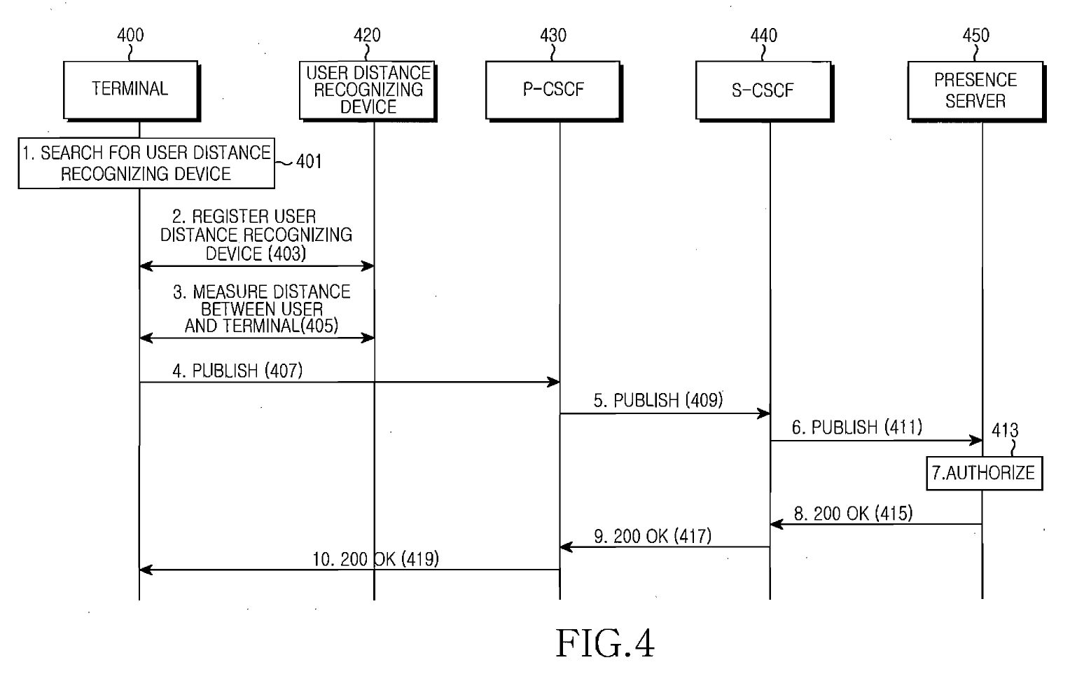

FIG. 4 is a signal flow diagram for automatically changing the presence status according to the distance variation between the portable communication terminal and the user according to the present invention.

Terminal 400 of FIG. 4 searches for a user-distance-recognizing device 420 in step 401 and registers the searched user-distance-recognizing device 420 to the memory as a device for measuring the distance between the user and the terminal 400 in step 403. The terminal 400 measures the distance between the user and the terminal 400 by transmitting and receiving radio signals to and from the user-distance-recognizing device 420 in step 405. When the measured distance between the user and the terminal 400 satisfies the condition for changing the presence status, the terminal 400 generates and sends the PUBLISH message, including the presence status change information, to P-CSCF 430 over a wired/wireless network in step 407. The P-CSCF 430 receives and forwards the PUBLISH message to the S-CSCF 440 in step 409. The S-CSCF 440 receives and forwards the PUBLISH message from the P-CSCF 430 to a presence server 450 in step 411. The presence server 450 performs the publisher authorization for the terminal 400 in step 413, changes the presence state with respect to the user, and generates and sends a 200 OK message to the S-CSCF 440 in step 415. The S-CSCF 440 forwards the 200 OK message to the P-CSCF 430 in step 417, and the P-CSCF 430 forwards the 200 OK message to the terminal 400 in step 419.

As set forth above, by measuring the distance between the portable communication terminal and the user and automatically changing the ring/vibrate mode, the ring volume, and the presence status according to the measured distance change, the user does not have to the terminal state one by one through the menu setup. Additionally, the user state can be accurately reflected in the presence service.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A terminal-state-setting method in a portable communication terminal, the method comprising:
measuring a distance between the terminal and a user-distance-recognizing device using a radio communication; and
setting a state of the terminal according to the measured distance value.

2. The terminal-state-setting method of claim 1, wherein the radio communication is one of Bluetooth, InfraRed Data Association (IrDA), Radio Frequency IDentification (RFID), and Ultra-WideBand (UWB) communication.

3. The terminal-state-setting method of claim 1, wherein the user-distance-recognizing device enables the radio communication and is embedded to an object carried along by a user.

4. The terminal-state-setting method of claim 1, further comprising:
searching for the user-distance-recognizing device using the radio communication when the terminal is powered on; and
registering the searched user-distance-recognizing device to a memory as a device for measuring the distance between the user and the terminal.

5. The terminal-state-setting method of claim 1, wherein the state of the terminal includes at least one of a ring/vibrate mode, a ring volume, and a presence status.

6. The terminal-state-setting method of claim 1, further comprising:
storing the measured distance value to the memory.

7. The terminal-state-setting method of claim 6, further comprising:
measuring the distance between the terminal and the user-distance-recognizing device using the radio communication after a certain time; and
calculating a change of the distance value using the measured distance value and a distance value measured before the certain time, and automatically changing the terminal state when the calculated distance value change is greater than a reference value.

8. The terminal-state-setting method of claim 7, further comprising:
entering a sleep mode for the certain time.

9. The terminal-state-setting method of claim 7, wherein the terminal state changing comprises:
when the calculated distance value change is greater than a reference value for changing the presence status of the terminal, generating and transmitting a PUBLISH message including presence status change information to a presence server.

10. The terminal-state-setting method of claim 7, wherein the terminal state changing comprises:
when the calculated distance value change is greater than a reference value for changing the ring/vibrate mode or the ring volume of the terminal, changing the ring/vibrate mode or the ring volume.

11. A terminal-state-setting apparatus in a portable communication terminal, comprising:
means for measuring a distance between the terminal and a user-distance-recognizing device using a radio communication; and
means for setting a state of the terminal according to the measured distance value.

12. The terminal-state-setting apparatus of claim 11, wherein the radio communication is one of Bluetooth, InfraRed Data Association (IrDA), Radio Frequency IDentification (RFID), and Ultra-WideBand (UWB) communication.

13. The terminal-state-setting apparatus of claim 11, wherein the user-distance-recognizing device enables the radio communication and is embedded to an object carried along by a user.

14. The terminal-state-setting apparatus of claim 11, further comprising:
means for searching for the user-distance-recognizing device using the radio communication when the terminal is powered on; and
means for registering the searched user-distance-recognizing device to a memory as a device for measuring the distance between the user and the terminal.

15. The terminal-state-setting apparatus of claim 1, wherein the state of the terminal includes at least one of a ring/vibrate mode, a ring volume, and a presence status.

16. The terminal-state-setting apparatus of claim 11, further comprising:
means for storing the measured distance value to the memory.

17. The terminal-state-setting apparatus of claim 16, further comprising:
means for measuring the distance between the terminal and the user-distance-recognizing device using the radio communication after a certain time; and
means for calculating a distance value change using the measured distance value and a distance value measured before the certain time, and automatically changing the terminal state when the calculated distance value change is greater than a reference value.

18. The terminal-state-setting apparatus of claim 17, wherein the means for changing the terminal state comprises:
means for generating and transmitting a PUBLISH message including presence status change information to a presence server when the calculated distance value change is greater than a reference value for changing the presence status of the terminal.

19. The terminal-state-setting apparatus of claim 17, wherein the means for changing the terminal state comprises:
means for changing the ring/vibrate mode or the ring volume when the calculated distance value change is greater than a reference value for changing the ring/vibrate mode or the ring volume of the terminal.

20. A terminal-state-setting apparatus comprising:
a terminal for measuring and storing a distance between the terminal and a user-distance-recognizing device using a radio communication, and setting a terminal state according to the measured distance value; and
the user-distance-recognizing device for performing the radio communication with the terminal, the user-distance-recognizing device embedded to an object carried along by a user.

21. The terminal-state-setting apparatus of claim 20, wherein the radio communication is one of Bluetooth, InfraRed Data Association (IrDA), Radio Frequency IDentification (RFID), and Ultra-WideBand and (UWB) communication.

22. The terminal-state-setting apparatus of claim 20, wherein the terminal state includes at least one of a ring/vibrate mode, a ring volume, and a presence status.

23. The terminal-state-setting apparatus of claim 20, wherein the terminal, when the terminal is powered on, searches for the user-distance-recognizing device using the radio communication and registers the searched user-distance-recognizing device to a memory as a device for measuring a distance between the user and the terminal.

24. The terminal-state-setting apparatus of claim 20, wherein the terminal, after a certain time, measures a distance between the terminal and the user-distance-recognizing device using the radio communication, calculates a distance value change using the measured distance value and a distance value measured before the certain time, and automatically changes the terminal state when the calculated distance change is greater than a reference value.

25. The terminal-state-setting apparatus of claim 24, wherein the terminal changes the ring/vibrate mode or the ring volume when the calculated distance value change is greater than a reference value for changing the ring/vibrate mode or the ring volume of the terminal.

26. The terminal-state-setting apparatus of claim 24, wherein the terminal generates and transmits a PUBLISH message including presence status change information to a presence server when the calculated distance value change is greater than a reference value for changing a presence status of the terminal.

27. The terminal-state-setting apparatus of claim 26, further comprising:
a presence service for performing a publisher authorization for the terminal when the PUBLISH message is received from the terminal, changing the presence status of a corresponding user using the presence status change information, and generating and transmitting a response message to the terminal.

28. The terminal-state-setting apparatus of claim 27, further comprising:
a Proxy-Call Signal Call Function (P-CSCF) for sending a PUBLISH message received from the terminal to a Serving-Call Signal Call Function (S-CSCF) and sending a response message received from the S-CSCF to the terminal; and
the S-CSCF for sending a PUBLISH message received from the P-CSCF to the presence server and sending a response message received from the presence server to the P-CSCF.
